(19) United States
(12) Patent Application Publication
(10) Pub. No.: US 2006/0271728 A1
(43) Pub. Date: Nov. 30, 2006

(54) A LOW AREA ARCHITECTURE SOLUTION FOR EMBEDDED FLASH PROGRAMMING MEMORIES IN MICROCONTROLLERS

(75) Inventors: Rosalino Critelli, Misterbianco (CT) (IT); Santi Carlo Adamo, Gravina di Catania (CT) (IT); Alessandro Inglese, San Giovanni La Punta (CT) (IT); Stefano Catalano, Catania (IT); Edmondo Gangi, S. Agata LI Battiati (CT) (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 11/420,846

(22) Filed: May 30, 2006

(30) Foreign Application Priority Data
May 31, 2005 (EP) 05011710.0

(51) Int. Cl. G06F 12/00

(52) U.S. Cl. 711/103

(57) ABSTRACT

A low area architecture for embedded programming flash memory portions in microcontrollers is based on substitution of the ROM/RAM/CORE functionality with a digital ISP controller implemented in a finite state machine and a standard interface. After connecting ports of the embedded programming flash memory portion and releasing a RESET pin, the microcontroller enters a particular operating mode and is managed by the digital ISP controller instead of the CORE. The ROM is not required to set up the microcontroller, and as a consequence, transfer of the boot program from the ROM to the RAM is not requested for subsequent execution.

### FIELD OF THE INVENTION

The invention relates to a low area architecture for embedded flash programming memories in microcontrollers. More particularly, but not exclusively, the invention relates to a low area architecture for programming a flash memory embedded in a microcontroller comprising a microcontroller core, an embedded flash memory portion, an input/output port and an interface between the core and the memory portion.

The following description relates to this specific field of application to make the illustration easier to understand.

### BACKGROUND OF THE INVENTION

Microcontrollers with embedded flash memories are widely used in applications from home appliances to automotive. The embedded flash memory is very useful in system programming. The application developer can update program code inside the embedded flash memory in the microcontroller, without removing it from the board, through a serial link connection with the programmer (i.e., the PC). The application developer can quickly modify the application program until it properly works.

In FIG. 1 a microcontroller with an embedded flash memory 10 is illustrated. Six pins on the microcontroller are identified as VDD, IPSEL, VSS, RESET, ISPCLK, ISPDATA. These pins are used to connect the microcontroller with a programming system through a port connection 2.

Even if not explicitly shown in FIG. 1, the system generally includes a RAM, a ROM, a flash memory and a CORE. In this kind of microcontroller architecture, the ROM is used to contain a boot program but it can generally be directly included in a reserved part of a Flash memory portion. The program stored in the ROM is previously written by the device manufacturer.

Through the above-mentioned six pins, the microcontroller embedded flash memory can be programmed. The boot program stored in the RON is used to configure the ports of the system during the start-up phase and to load the RAM memory. When the microcontroller is powered on, and before using it for any applications, a user needs to program the embedded flash memory with program codes, which allows the microcontroller to operate as needed.

In particular, after connecting the ports as shown in FIG. 1, the programmer begins a procedure, after the RESET pin is released, to put the microcontroller in an ISP mode. The ISP mode is indicated as a programming phase of the microcontroller.

When in the ISP mode, the microcontroller executes the boot program located in the embedded ROM to configure the I/O port of the serial link (ISPDATA, ISPCLK) and to load the bootstrap program in the RAM. Then the microcontroller CORE fetches, decodes and executes the bootstrap program code from the RAM and reads data through the serial link to program the flash memory.

FIG. 2 is a block diagram describing the transition state of the microcontroller during the start up phase. In particular, to put the microcontroller in the ISP mode the two pins IPSEL and ISPDATA need to be configured.

When the microcontroller is in the ISP mode, the boot ROM is executed through the ISPDATA to read and load the bootstrap program in the RAM. Then the control jumps to the RAM to execute the bootstrap program. The bootstrap program reads data through the serial link and programs the flash memory and the option bytes.

As previously mentioned, in this system architecture the CORE is switched on to fetch, decode and execute the bootstrap program from the RAM, and a dedicated nonstandard serial link/protocol interface is needed for this task. For example, in the prior art document “Atmega32: 8-bit AVR Microcontroller with 32K Bytes In-System Programmable Flash”, in the name of Atmel Corporation, at page 218, a block diagram representing a device architecture is schematically represented. The device comprises input/output ports and four additional pins TDI, TDO, TCK and TMS linked to a TAP controller that is in communication with the core.

According to this approach, the core is involved both in a normal mode execution and in a programming mode execution. In this way, it is not possible to use the core in the normal mode execution, such as for executing code on a first memory, while the TAP controller is executing in the programming mode, such as on second memory or on an additional device, for example. This is a drawback for increasing system performance.

### SUMMARY OF THE INVENTION

In view of the foregoing background, an object of the present invention is to simplify the above-described embedded flash memory programming system. More particularly, the object is to reduce the configuration complexity of the start-up phase due to the need of interfacing the microcontroller with the embedded memory portions for reading the ROM, for transferring the boot program in the RAM and for the subsequent execution of the program.

Another object is to provide an architecture for embedded flash programming not based on a ROM and structured to at least reduce internal switch noise when switching off the CORE during a programming phase, and to reduce flash memory programming time avoiding downloading code in the RAM through boot ROM execution.

According to one embodiment, the system architecture is free from the ROM to improve not only the performance but also for addressing the testing problems related to the ROM and to achieve a system full scan test. Also, the manufacturer may not need to previously store a boot program in the ROM or in a dedicated part of the flash.

According to a more specific aspect, a standard serial link protocol is used to interface the microcontroller instead of a nonstandard protocol, as it will be clear in the following more detailed description.

### BRIEF DESCRIPTION OF THE DRAWINGS

The features and advantages of the invention will be apparent from the following description of an embodiment thereof, given by way of a non-limitative example with reference to the accompanying drawings.

FIG. 1 represents in a schematic view a microcontroller with an embedded flash memory, and a series of pins used for programming the flash memory according to the prior art.

FIG. 2 represents a block diagram describing the microcontroller core fetch, decoding and execution phases according to the prior art.

FIG. 3 represents a block diagram describing the digital ISP controller command according to the architecture of the present invention.

FIG. 4 represents the ISP controller decoding commands according to the architecture of the present invention.

### DETAILED DESCRIPTION OF THE PREFERRED EMBODIMENTS

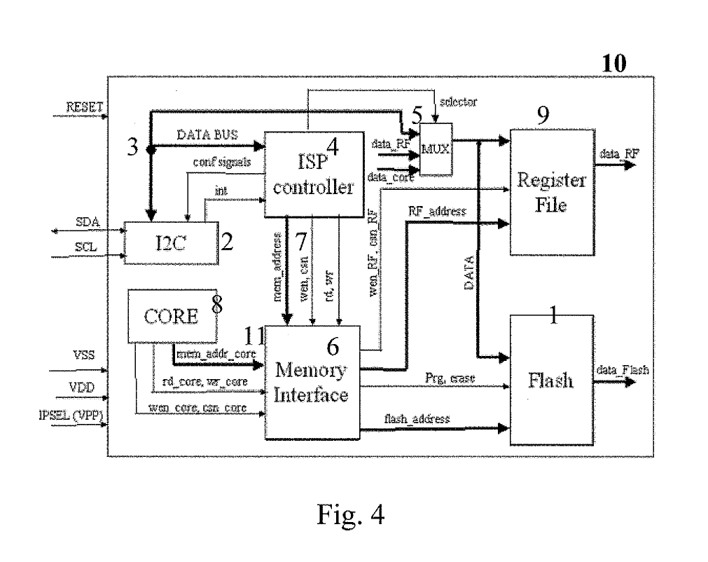

A microcontroller 10 with an embedded flash memory 1 is schematically shown in FIG. 4. A simplified architecture is provided for embedded flash programming that substitutes the ROM functionality through a digital ISP controller able to work with standard protocol links, and without creating internal switch noise when switching off the microcontroller core during a programming phase.

In particular, on the left side of FIG. 4, six pins are indicated: RESET, SDA, SCL, VSS, VDD and IPSEL. Two of these pins are connected directly with the I2C serial interface 2, which is a peripheral already embedded into the device for normal mode operation.

The I2C peripheral 2 is connected through the DATA_BUS 3 to the ISP controller 4 and to a multiplexer 5. The memory interface 6 is connected to the ISP controller 4 through a mem_address line connection 7 and to the CORE 8 through a mem_addr_core line connection 11.

A ROM is not required to set up the microcontroller, and as a consequence, transferring the boot program from the ROM to the RAM is not requested for subsequent execution.

The register file 9 is connected to the MUX 5 and to the memory interface 6 while the flash memory 1 is connected to the MUX 5 and the memory interface 6.

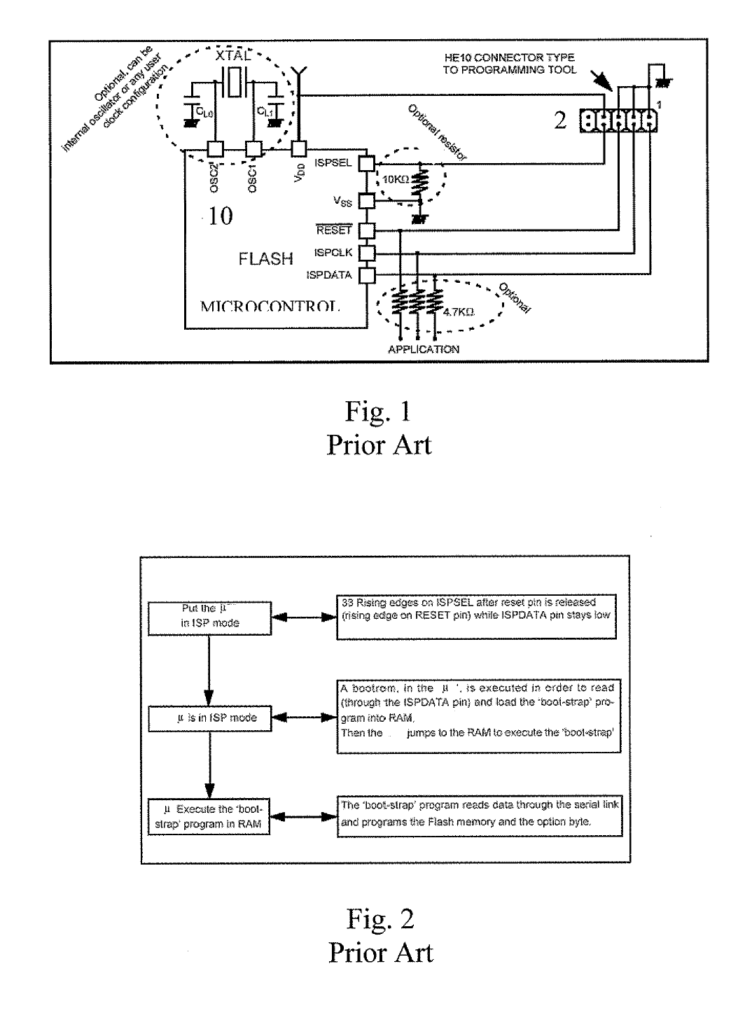

After connecting the ports as in FIG. 1 and releasing the RESET pin, the microcontroller enters the ISP mode and is managed by the digital ISP controller 4 instead of the CORE 8 as in the normal mode. The digital ISP controller 4 is a very small finite state machine and its contribution to the total area and complexity is negligible.

When in the ISP mode, the digital ISP controller 4 configures the I/O ports. After that, the digital ISP controller 4 manages the standard I2C 2 serial links SDA and SCL, and waits for command from a programmer.

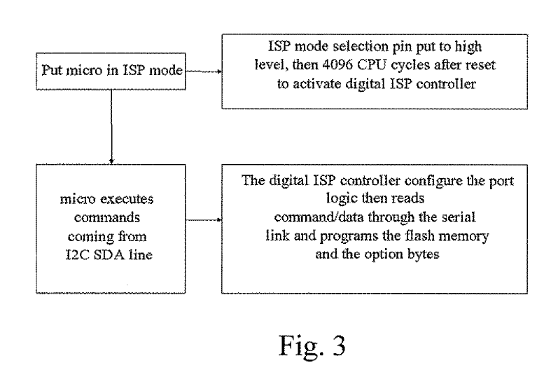

In this way, no ROM is needed and no bootstrap program is downloaded and executed in the RAM by the CORE 8. Program code execution by the CORE 8 is replaced, in this architecture, with commands executed by the digital ISP controller 4, as shown schematically in FIG. 3.

In the following TABLE 1 the commands received by the I2C interface 2 and sent to the ISP 4 controller through the common DATA_BUS 3 are reported.

TABLE 1

| Command | Code | Description |
|---|---|---|
| BlockWrite | 00000001 | First erase block currently |
| | | pointed, then write the 64 |
| | | bytes |
| ByteWrite | 00000010 | First erase, then write byte in |
| | | currently pointed page and |
| | | offset |
| BlockErase | 00000011 | Erase the block of the provided |
| | | offset inside the current page |
| ByteErase | 00000100 | Erase the byte with the |
| | | provided offset inside the |
| | | current page |
| ByteRead | 00000101 | Read the byte with the provided |
| | | offset inside the current page |
| FastByteWrite | 00001000 | Like ByteWrite but without |
| | | erase |
| GlobalErase | 00001001 | Erase all first 32 K byte |
| | | Program memory |
| FastBlkWrite | 00001011 | Like BlockWrite but without |
| | | erase |
| SetPage | 00001100 | Update page pointer with |
| | | provided value |
| ReadData | 00001101 | Read the currently pointed byte |
| | | and update address by one |
| IncBlk | 00001111 | Update current block pointer by |
| | | one |
| ReadStatus | 00010011 | Read current Status Register |
| | | and exit ISP mode |

This table thus reports the commands for the digital ISP controller 4. Then the ISP controller 4 decodes these commands, sends address (mem_address), data (DATA_BUS) and read/write signals (rd, wr, wen, csn) to the memory interface to program the flash memory and option bytes, as shown in FIG. 4.

The ISP controller 4 provides address and read/write signals for the register file 9 and memory 6 only in the ISP mode. While in the normal mode, they are provided by the CORE 8 (through mem_addr_core, wen_core, csn_core, rd_core and wr_core link). For this purpose, a MUX stage is present inside the memory interface to select, depending on the microcontroller mode, if the CORE 8 or the ISP controller 4 are generating flash and register file addresses.

If the microcontroller is in the ISP mode, the ISP controller 4 generates a flash_address directed to the flash memory 1, an RF_address directed to the register file 9, read/write signals wen_RF and csn_RF are also directed to the register file 9 and prg and erase signals are directed to the flash memory 1.

If the microcontroller 10 runs in the normal mode, the CORE 8 is responsible for generating and addressing the addresses described above. The same happens not only for addresses but also for data in the MUX of FIG. 4. Data can come from the CORE 8 (through data_core) or from the ISP controller 4 (DATA_BUS) in the ISP mode.

The other input of the MUX is data coming from the register files 9 that need to be swapped on flash during a BlockWrite command when the ISP controller first loads the 64 bytes in the register files, then swaps them on flash.

The ISP controller 4 is responsible to manage the MUX selector signal. In conclusion, we can see that in the ISP mode the CORE 8 does not need to fetch, decode and execute a bootstrap program from the RAM. So it can be switched off, thus reducing internal noise.

Advantageously, the ISP controller 4 is independent of the CORE 8, and the low area architecture supports a contemporary execution of the ISP controller in the programming mode and the CORE 8 in the normal mode.

Moreover, the ISP controller 4 is connected to a standard input/output port comprising only two pins so that no additional peripheral intended to be used in the programming mode and requiring additional pins are needed.

1-10. (canceled)

11. A microcontroller comprising:
an embedded programming flash memory;
a microcontroller core;
an input/output serial port;
a memory interface coupled between said microcontroller core and said embedded programming flash memory; and
a digital ISP controller coupled to said input/output serial port and to said memory interface, said digital ISP controller for driving said memory interface.

12. A microcontroller according to claim 11, further comprising a data bus and a memory address bus; and wherein said digital ISP controller is coupled to said input/output serial port through said data bus and to said memory interface through said memory address bus.

13. A microcontroller according to claim 11, further comprising a multiplexer and a selector coupled thereto; and wherein said digital ISP controller is coupled to said multiplexer through said selector for selecting an ISP mode or a normal mode.

14. A microcontroller according to claim 13, wherein said digital ISP controller is selectable in the ISP mode or in the normal mode when said microcontroller core is in the normal mode.

15. A microcontroller according to claim 11, further comprising a plurality of serial pins coupled to said input/output serial port; and wherein said plurality of serial pins are driven by said digital ISP controller when in the ISP mode.

16. A microcontroller according to claim 11, wherein said digital ISP controller comprises a finite state machine.

17. A microcontroller according to claim 16, wherein said digital ISP controller performs internally a programming phase independently from said microcontroller core.

18. A microcontroller according to claim 11, wherein code for programming the embedded programming flash memory in the microcontroller is decoded by said digital ISP controller from data coming through said input/output serial port.

19. A microcontroller according to claim 13, wherein the said multiplexer manages said microcontroller core and said digital ISP controller for generating flash and register file addresses based on the ISP mode or the normal mode being selected.

20. A microcontroller comprising:
an embedded programming flash memory;
a microcontroller core;
a memory interface coupled between said microcontroller core and said embedded programming flash memory;
an input/output serial port; and
an ISP controller coupled to said input/output serial port and to said memory interface, said ISP controller for driving said memory interface and being independent of said microcontroller core.

21. A microcontroller according to claim 20, further comprising a data bus and a memory address bus; and wherein said ISP controller is coupled to said input/output serial port through said data bus and to said memory interface through said memory address bus.

22. A microcontroller according to claim 20, further comprising a multiplexer; and wherein said ISP controller is coupled to said multiplexer for selecting an ISP mode or a normal mode.

23. A microcontroller according to claim 22, wherein said ISP controller is selectable in the ISP mode or in the normal mode when said microcontroller core is in the normal mode.

24. A microcontroller according to claim 20, further comprising a plurality of serial pins coupled to said input/output serial port; and wherein said plurality of serial pins are driven by said ISP controller when in the ISP mode.

25. A microcontroller according to claim 20, wherein said ISP controller comprises a finite state machine.

26. A microcontroller according to claim 25, wherein said ISP controller performs internally a programming phase independently from said microcontroller core.

27. A microcontroller according to claim 20, wherein code for programming said embedded programming flash memory is decoded by said ISP controller from data coming through said input/output serial port.

28. A microcontroller according to claim 22, wherein the said multiplexer manages said microcontroller core and said ISP controller for generating flash and register file addresses based on the ISP mode or the normal mode being selected.

29. A method for operating a microcontroller comprising an embedded programming flash memory; a microcontroller core; an input/output serial port; and a memory interface between the microcontroller core and the embedded programming flash memory, the method comprising:
using an ISP controller coupled to the input/output serial port and to the memory interface for driving the memory interface.

30. A method according to claim 29, wherein the ISP controller operates independent of the microcontroller core.

31. A method according to claim 29, wherein the microcontroller further comprises a data bus and a memory address bus; and wherein the ISP controller is coupled to the input/output serial port through the data bus and to the memory interface through the memory address bus.

32. A method according to claim 29, wherein the microcontroller further comprises a multiplexer; and wherein the ISP controller is coupled to the multiplexer for selecting an ISP mode or a normal mode.

33. A method according to claim 32, wherein the ISP controller is selectable in the ISP mode or in the normal mode when the microcontroller core is in the normal mode.

34. A method according to claim 29, wherein the microcontroller further a plurality of serial pins coupled to the input/output serial port; and wherein the plurality of serial pins are driven by the ISP controller when in the ISP mode.

35. A method according to claim 29, wherein the ISP controller comprises a finite state machine.

36. A method according to claim 35, wherein the ISP controller performs internally a programming phase independently from the microcontroller core.

37. A method according to claim 29, wherein code for programming the embedded programming flash memory in the microcontroller is decoded by the ISP controller from data coming through the input/output serial port.

38. A method according to claim 32, wherein the multiplexer manages the microcontroller core and the ISP controller for generating flash and register file addresses based on the ISP mode or the normal mode being selected.
